(19) United States
(12) Patent Application Publication
(10) Pub. No.: US 2019/0296311 A1
(43) Pub. Date: Sep. 26, 2019

(54) BATTERY CELL FOR ELECTRIC VEHICLE BATTERY PACK

(71) Applicant: SF Motors, Inc., Santa Clara, CA (US)

(72) Inventors: Brennan Campbell, Santa Clara, CA (US); Scott Quinlan Freeman Monismith, Santa Clara, CA (US)

(21) Appl. No.: 16/133,041

(22) Filed: Sep. 17, 2018

Related U.S. Application Data
(60) Provisional application No. 62/646,991, filed on Mar. 23, 2018.

(51) Int. Cl. H01M 2/20; B60L 11/18; H01M 10/643; H01M 2/02; H01M 2/30; H01M 2/10

(52) U.S. Cl. CPC H01M 2/206; B60L 11/18; H01M 10/643; H01M 2220/20; H01M 2/30; H01M 2/1077; H01M 2/022

(57) ABSTRACT

A battery pack can include a battery cell. The battery cell can include a first polarity terminal. The battery cell can include a housing having a closed end and an open end. The open end can define a lip. The battery cell can include a second polarity terminal that includes the lip. The battery cell can include a bridge electrically coupled with the lip and extending over a portion of the first polarity terminal. The battery pack can include a busbar. The busbar can include a first conductive layer having a first opening aligned with the lip. The busbar can include a second conductive layer having a second opening. The battery pack can include a first wire to electrically couple the bridge with the first conductive layer. The battery pack can include a second wire to electrically couple the first polarity terminal with the second conductive layer.

### CROSS-REFERENCE TO RELATED APPLICATIONS

The present application claims priority under 35 U.S.C. § 119 U.S. Provisional Patent Application 62/646,991, filed Mar. 23, 2018 and titled “BATTERY CELL FOR ELECTRIC VEHICLE BATTERY PACK,” which is incorporated herein by reference in its entirety.

### BACKGROUND

Electric vehicles such as automobiles can include on-board battery cells or battery packs to power the electric vehicles.

### SUMMARY

At least one aspect of this disclosure is directed to a battery pack to power an electric vehicle. The battery pack can include a battery cell. The battery cell can include a first polarity terminal disposed at a lateral end of the battery cell. The battery cell can include a housing having a closed end and an open end. The open end can define a lip that surrounds the first polarity terminal. The battery cell can include a second polarity terminal that includes the lip. The battery cell can include a bridge electrically coupled with the lip and extending over a portion of the first polarity terminal. The battery pack can include a busbar. The busbar can include a first conductive layer having a first opening aligned with the lip. The busbar can include a second conductive layer having a second opening. The battery pack can include a first wire having a first end and a second end. The first end of the first wire can be bonded with the bridge. The second end of the first wire can be bonded with the first conductive layer to electrically couple the first polarity terminal with the first conductive layer. The battery pack can include a second wire having a first end and a second end. The first end of the second wire can be bonded with the first polarity terminal. The second end of the second wire can be bonded with the second conductive layer to electrically couple the first polarity terminal with the second conductive layer.

At least one aspect of this disclosure is directed to a method of providing battery packs. The method can include forming a housing for a battery cell of the battery pack. The housing can have a closed end and an open end. The open end can define a lip. The method can include providing a first polarity terminal at a lateral end of the housing. The lip of the housing can surround the first polarity terminal. The method can include electrically coupling a bridge with the lip of the housing to form a second polarity terminal. The bridge can extend over a portion of the first polarity terminal. The method can include providing a busbar including a first conductive layer having a first opening aligned with the lip and a second conductive layer having a second opening. The method can include electrically coupling the bridge with the first conductive layer of the busbar via a first wire. The method can include electrically coupling the first polarity terminal with the second conductive layer of the busbar via a second wire.

At least one aspect of this disclosure is directed to an electric vehicle. The electric vehicle can include a battery pack installed in the electric vehicle to power the electric vehicle. The battery pack can include a battery cell. The battery cell can include a first polarity terminal disposed at a lateral end of the battery cell. The battery cell can include a housing having a closed end and an open end. The open end can define a lip that surrounds the first polarity terminal. The battery cell can include a second polarity terminal that includes the lip. The battery cell can include a bridge electrically coupled with the lip and extending over a portion of the first polarity terminal. The battery pack can include a busbar. The busbar can include a first conductive layer having a first opening aligned with the lip. The busbar can include a second conductive layer having a second opening. The battery pack can include a first wire having a first end and a second end. The first end of the first wire can be bonded with the bridge. The second end of the first wire can be bonded with the first conductive layer to electrically couple the second polarity terminal with the first conductive layer. The battery pack can include a second wire having a first end and a second end. The first end of the second wire can be bonded with the first polarity terminal. The second end of the second wire can be bonded with the second conductive layer to electrically couple the first polarity terminal with the second conductive layer.

At least one aspect of this disclosure is directed to a method. The method can include providing a battery pack to power an electric vehicle. The battery pack can include a battery cell. The battery cell can include a first polarity terminal disposed at a lateral end of the battery cell. The battery cell can include a housing having a closed end and an open end. The open end can define a lip that surrounds the first polarity terminal. The battery cell can include a second polarity terminal that includes the lip. The battery cell can include a bridge electrically coupled with the lip and extending over a portion of the first polarity terminal. The battery pack can include a busbar. The busbar can include a first conductive layer having a first opening aligned with the lip. The busbar can include a second conductive layer having a second opening. The battery pack can include a first wire having a first end and a second end. The first end of the first wire can be bonded with the bridge. The second end of the first wire can be bonded with the first conductive layer to electrically couple the second polarity terminal with the first conductive layer. The battery pack can include a second wire having a first end and a second end. The first end of the second wire can be bonded with the first polarity terminal. The second end of the second wire can be bonded with the second conductive layer to electrically couple the first polarity terminal with the second conductive layer.

These and other aspects and implementations are discussed in detail in this disclosure. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an example battery cell for an electric vehicle battery pack;

FIG. 2 depicts a top down view of an example battery cell for an electric vehicle battery pack;

FIG. 3 depicts a top down view of an example battery cell for an electric vehicle battery pack;

FIG. 4 depicts a top down view of an example conductive layer of a busbar;

FIG. 5 depicts a top down view of an example conductive layer of a busbar;

FIG. 6 depicts a top down view of an example battery submodule array including a plurality of batteries;

FIG. 7 depicts a cross-sectional view of a portion of an example battery submodule array and a busbar;

FIG. 8 is a block diagram depicting a cross-sectional view of an example battery pack for holding battery cells in an electric vehicle;

FIG. 9 is a block diagram depicting a top-down view of an example battery pack for holding battery cells in an electric vehicle;

FIG. 10 is a block diagram depicting a cross-sectional view of an example electric vehicle installed with a battery pack;

FIG. 11 depicts a flow chart of an example process of providing a battery pack; and

FIG. 12 depicts a flow chart of an example process of providing a battery pack.

Following are more detailed descriptions of various concepts related to, and implementations of, methods, apparatuses, and systems of battery cells for electric vehicles. The various concepts described in this disclosure may be implemented in any of numerous ways, as the described concepts are not limited to any particular manner of implementation.

### DETAILED DESCRIPTION

Systems and methods described herein relate to battery cells for battery packs that can provide power to electric vehicles (“EVs”). Battery packs, which can be referred to herein as battery modules, that include a plurality of individual battery cells can also include wire bonds to form electrical connections between the individual positive and negative terminals of the battery cells of the battery pack and positive or negative busbars or current collectors. The wire bonding can be a technical challenge. For instance, wire bonding battery cells having a cylindrical cell form factor for a large vehicle battery pack design can be complicated due to size, space, and terminal location constraints. Hence, many technical issues surrounding assembly of battery cells into an EV module or pack can arise. One problem can be the wire bonding area of the negative terminal of the battery cell, which can include all or part of the negative housing or “can” in which an electrolyte material or “jelly roll” is housed. Because an array of battery cells can be connected in parallel or in series within a battery module, for example, wire bonding can be used to weld aluminum or nickel wire (or other conductive material) from the negative terminal (e.g., the can or housing) of one battery cell to the positive terminal of the adjacent cell, and so on, or to a busbar or current collector.

The bonding or welding area for the negative terminal can be the lip or rim of the housing disposed at or over one lateral end (e.g., the top end) of the battery cell. However, this welding area for the wire to be bound on the lip of the negative can (the uppermost part of the negative can that overlaps the gasket after a crimping process of cell fabrication) can have a small surface area that can be difficult to access or to affect a proper wire bond. This lip can include a thin area that surrounds a perimeter of the battery cell, and the wire bonding can be carried on along the width of the lip. The width of the lip can be approximately (e.g., +/−15%) 6 millimeters. This small surface area for wire bonding, combined with other factors, can cause a high wire bonding failure rate (e.g., greater than 60%), which can necessitate a costly, time consuming, or less effective re-weld procedure.

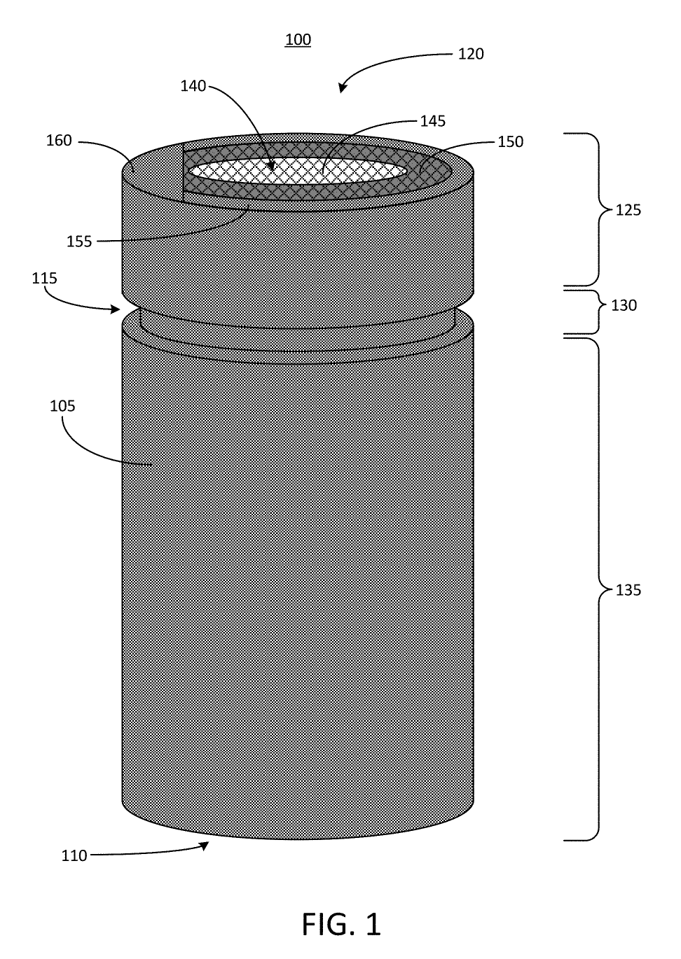

FIG. 1 depicts a perspective view of an example battery cell 100 for an electric vehicle battery pack. The battery cell 100 includes at least one housing 105. The housing 105 can extend between a closed end 110 and an open end 120. The housing 105 can include a groove 115 to define separate portions of the housing 105. For example, the housing 105 can include a head region 125, a neck region 130, and a body region 135. The head region 125 of the housing 105 can include a portion of the housing 105 positioned between the open end 120 and the groove 115. The neck region 130 of the housing 105 can correspond to the area of the groove 115. The body region 125 of the housing 105 can include a portion of the housing 105 positioned between the closed end 110 and the groove 115. A first polarity terminal 140 (e.g., positive or negative) can be positioned near the open end 120 (e.g., a lateral end of the battery cell 100). The first polarity terminal 140 can include a upper portion 145 and a lower portion 150. For example, the first polarity terminal 140 can be formed in a “table top” configuration in which the terminal includes a raised portion (e.g., the upper portion 145) that is positioned at an elevated height relative to the lower portion 150. In some examples, the upper portion 145 of the first polarity terminal 140 can serve as a bonding region to which a wire or other conductive element can be bonded to electrically couple the first polarity terminal 140 to a busbar or current collector. The housing 105 defines a lip 155 at the open end 120 of the housing 105. The lip 155 can surround the first polarity terminal 140.

The housing 105 can house an electrolyte material to provide electric power to the battery cell 100. For example, at least a portion of the electrolyte material (e.g., a positively charged portion of the electrolyte material) can be electrically coupled with the first polarity terminal 140. The housing 105 itself can serve as a second polarity terminal (e.g., positive or negative). For example, the lip 155 of the housing 105 can serve as a bonding region to which a wire or other conductive element can be bonded to carry electricity to a busbar or current collector. The housing 105 can therefore be formed from an electrically conductive material, such as steel, copper, aluminum, nickel, or nickel plated steel. The housing 105 can also be electrically coupled with a second portion (e.g., a negatively charged portion) of the electrolyte material contained within the housing 105. The lip 155 may have a relatively narrow width. For example, a width of the lip 155 can be less than 1 millimeter, less than 2 millimeters, or less than 3 millimeters. Due to the small size of the lip 155, it can be difficult to bond a wire to the lip 155. For example, attempts to bond a wire (e.g., via a welding technique) to the lip 155 may have a high failure rate requiring a re-bonding operation to be performed.

To address this technical challenge, the battery cell 100 can include one or more bridges 160. The bridge 160 can be an electrically conductive element that is electrically coupled with the lip 155 of the housing 105. The bridge 160 can have a width or a surface area substantially larger than that of the lip 155. For example, the width of the bridge 160 can be between 4 millimeters and 8 millimeters. In some examples, the width of the bridge 160 can be about 6 millimeters. The length of the bridge 160 can be between 10 and 20 millimeters. For example, the length of the bridge 160 can be about 15 millimeters. Thus, the surface area of the bridge 160 can be larger than the surface area of the lip 155, which can make it easier to successfully bond a wire to the bridge 160 than to the lip 155. The bridge 160 can be coupled with the lip 155 in a manner that forms an electrical connection between the bridge 160 and the lip 155. For example, a welding technique (e.g., ultrasonic welding, resistive spot welding, or laser welding) can be used to bond the bridge 160 to the lip 155. As a result, the bridge 160 can serve as the second polarity terminal of the battery cell 100. In some examples, the bridge 160 can be formed from an electrically conductive material, such as steel, nickel, nickel plated steel, copper, aluminum, a metal alloy, or any other conductive material that is capable of being welded or otherwise bonded with the lip 155. The bridge 160 can also be formed from the same material selected for the housing 105.

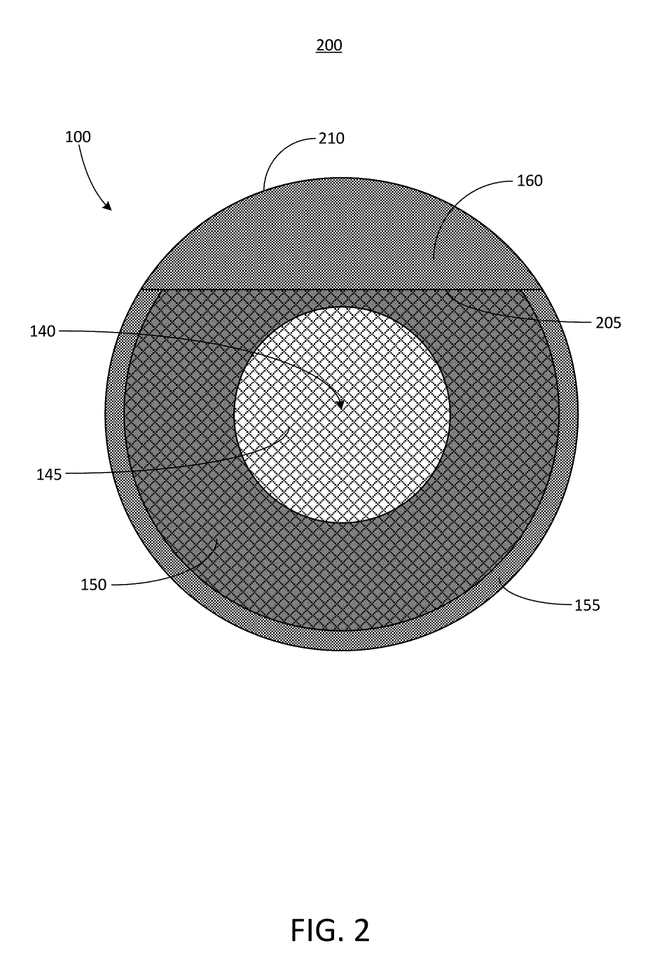

FIG. 2 depicts a top down view 200 of an example battery cell 100 for an electric vehicle battery pack. The battery cell 100 can have a circular cross-sectional shape. The first polarity terminal 140 can be positioned in a center of the battery cell 100. The first polarity terminal 140 can be surrounded by the lip 155 of the housing 105. The bridge 160 can be coupled with a portion of the lip 155. The bridge 160 can extend over at least a portion of the first polarity terminal 140. For example, the bridge 160 can extend over part or all of the lower portion 150 of the first polarity terminal 140. In some examples, the bridge 160 may also extend over part or all of the upper portion 145 of the first polarity terminal 140.

The bridge 160 includes a first edge 205 and a second edge 210. The first edge 205 can be linear, and can be positioned over a portion of the first polarity terminal 140. A majority of the first edge 205 of the bridge 160 can be suspended above the first polarity terminal 140, to prevent the bridge 160 from forming an electrical connection with the first polarity terminal 140. The second edge 210 of the bridge 160 can have a curved shape. For example, the second edge 210 of the bridge 160 can have a shape that conforms to or is otherwise aligned with a curvature of the lip 155 of the housing 105. As a result, the inclusion of the bridge 160 may not result in any change to a size or shape of a footprint of the battery cell 100, as the second edge 210 of the bridge 160 is aligned with a perimeter edge of the battery cell 100 (e.g., the housing 105). The housing 105 can have a diameter between 15 millimeters and 25 millimeters. The second edge 210 of the bridge 160 can be bonded to the lip 155 of the housing 105. In some other examples, the bridge 160 can be formed integrally with housing 105. For example, the housing 105 can have a shape that, when subjected to one or more crimping operations to form the groove 115 defining the head region 125, the neck region 130, and the body region 135, also results in a lip 155 that includes a portion having a larger surface area (e.g., a surface area matching that of the bridge 160 shown in FIG. 2).

The bridge 160 can have a shape that is a section of a circle. For example, the bridge 160 can have a semicircular shape. In some examples, the bridge 160 can have a shape that is larger or smaller than a semicircle. The bridge 160 can also have other shapes. For example, the bridge 160 can be rectangular, semi-circular, partially circular (e.g., less than a semi-circle), quadrilateral or polygonal in shape. As shown, the bridge 160 can provide a significantly larger bonding surface to which a wire or other conductive element can be bonded, as compared to the lip 155. As a result, bonding of such a wire or other conductive element can be achieved more easily due to the presence of the bridge 160. Wire bonds formed on the bridge 160 may also be more reliable (e.g., may have a lower failure rate) than wire bonds formed on the lip 155 of the housing 105.

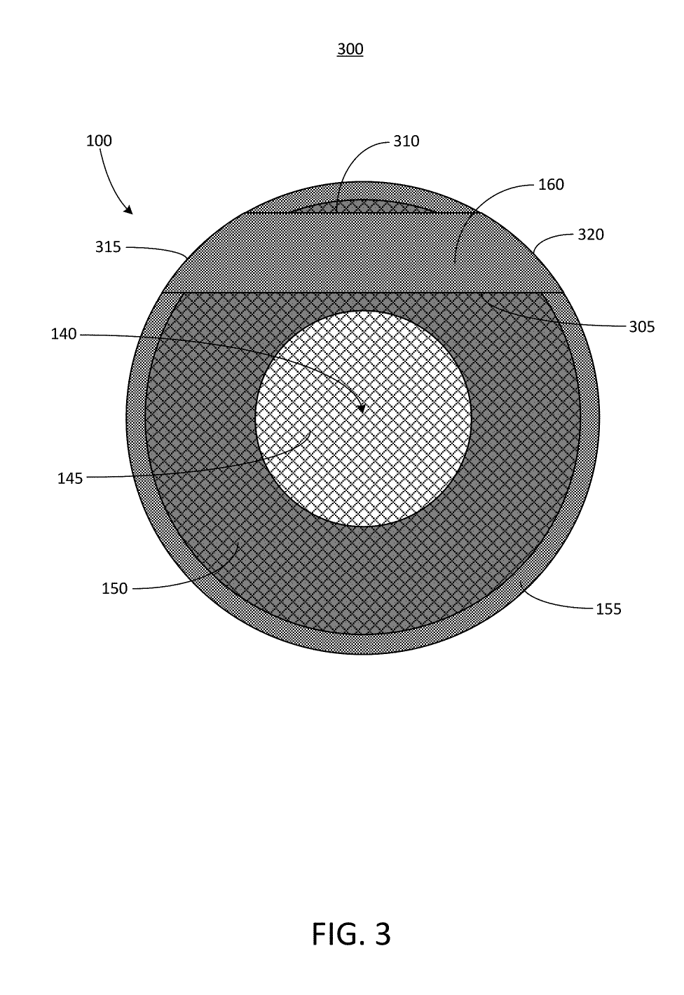

FIG. 3 depicts a top down view 300 of an example battery cell 100 for an electric vehicle battery pack. The battery cell 100 can have a circular cross-sectional shape. The first polarity terminal 140 can be positioned in a center of the battery cell 100. The first polarity terminal 140 can be surrounded by the lip 155 of the housing 105. The bridge 160 can be coupled with a portion of the lip 155. The bridge 160 can extend over at least a portion of the first polarity terminal 140. For example, the bridge 160 can extend over part or all of the lower portion 150 of the first polarity terminal 140. In some examples, the bridge 160 may also extend over part or all of the upper portion 145 of the first polarity terminal 140.

The bridge 160 includes a first edge 305, a second edge 310, a third edge 315, and a fourth edge 320. Both the first edge 305 and the second edge 310 can be linear and can extend over at least a portion of the first polarity terminal 140. For example, the first edge 305 and the second edge 310 of the bridge 160 can extend over the lower portion 150 of the first polarity terminal 140. The first edge 305 and the second edge 310 can be positioned on opposite sides of the bridge 160. The first edge 305 and the second edge 310 can extend in directions that are parallel to one another. The first edge 305 and the second edge 310 of the bridge 160 can be suspended above the first polarity terminal 140 in a manner that prevents the bridge 160 from coming into contact or otherwise forming an electrical connection with the first polarity terminal 140. Thus, the bridge 160 can remain electrically isolated from the first polarity terminal 140.

The third edge 315 and the fourth edge 320 can be positioned on opposite sides of the bridge 160. Each of the third edge 315 and the fourth edge 320 can be positioned between the first edge 305 and the second edge 310. The third edge 315 and the fourth edge 320 can each have a curved shape. For example, a curvature of each of the third edge 315 and the fourth edge 320 can be aligned with or can conform to a curvature of the lip 155 of the housing 105. As a result, the inclusion of the bridge 160 may not result in any change to a size or shape of a footprint of the battery cell 100, as the third edge 315 and the fourth edge 320 of the bridge 160 are aligned with a perimeter edge of the battery cell 100 (e.g., the housing 105). The third edge 315 and the fourth edge 320 can be bonded to lip 155. In some other examples, the bridge 160 can be formed integrally with housing 105. For example, the housing 105 can have a shape that, when subjected to one or more crimping operations to form the groove 115 defining the head region 125, the neck region 130, and the body region 135, also results in a lip 155 that includes a portion having a larger surface area (e.g., a surface area matching that of the bridge 160 shown in FIG. 3).

The bridge 160 can have a shape that is a section of a circle. For example, the bridge 160 can have a semicircular shape. In some examples, the bridge 160 can have a shape that is larger or smaller than a semicircle. As shown, the bridge 160 can provide a significantly larger bonding surface to which a wire or other conductive element can be bonded, as compared to the lip 155. As a result, bonding of such a wire or other conductive element can be achieved more easily due to the presence of the bridge 160. Wire bonds formed on the bridge 160 may also be more reliable (e.g., may have a lower failure rate) than wire bonds formed on the lip 155 of the housing 105.

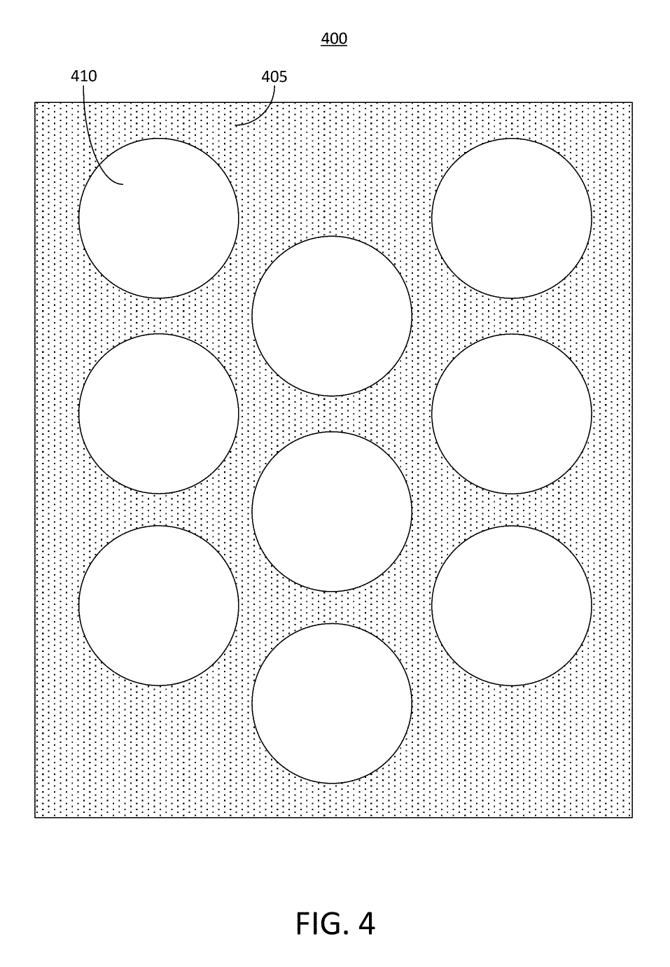

FIG. 4 depicts a top down view 400 of an example conductive layer 405 of a busbar. The conductive layer 405 can be a flat or planar component configured to provide a bonding surface to be electrically coupled with a plurality of battery cells, such as the battery cell battery cell 100. For example, by electrically coupling a first polarity terminal or a second polarity terminal of each of a plurality of battery cells 100 to the conductive layer 405, the conductive layer 405 can serve as a current collector for all of the battery cells 100. Thus, the battery cells 100 may be electrically connected in parallel through use of the conductive layer 405.

The conductive layer 405 can include a plurality of openings 410. Each of the openings 410 can be configured to provide space through which a respective battery cell 100 can be accessed, and through which electrical connections can be formed between each respective battery cell 100 and the conductive layer 405. For example, the openings 410 can provide space for one or more wires to be positioned, and the one or more wires can electrically couple one or more terminals of one or more batteries with the conductive layer 405. The openings 410 can each have a shape that matches a cross-sectional shape of the battery cells 100 to be coupled with the conductive layer 405. For example, each conductive layer 405 can have a circular shape. The openings 410 can also have a size that matches a size of the battery cells 100 to be coupled with the conductive layer 405. For example, a diameter or circumference distance of each opening 410 can be selected to match a corresponding diameter or circumference of the battery cells 100. In some examples, each opening 410 can have a diameter between 15 millimeters and 25 millimeters.

The openings 410 can be arranged in a staggered pattern of rows and columns as shown in FIG. 4. However, other arrangements are also possible. For example, the openings 410 can be arranged in a grid pattern. The conductive layer 405 can include any number of openings 410. For example, the conductive layer 405 can include four, five, six, seven, eight, nine, 10, 11, 12, 13, 14, 15, or 16 openings 410. The conductive layer 405 can also include a number of openings 410 greater than 16 or less than four. For example, the conductive layer 405 may include between 20 and battery cell 100 openings 410, or may contain more than battery cell 100 openings 410.

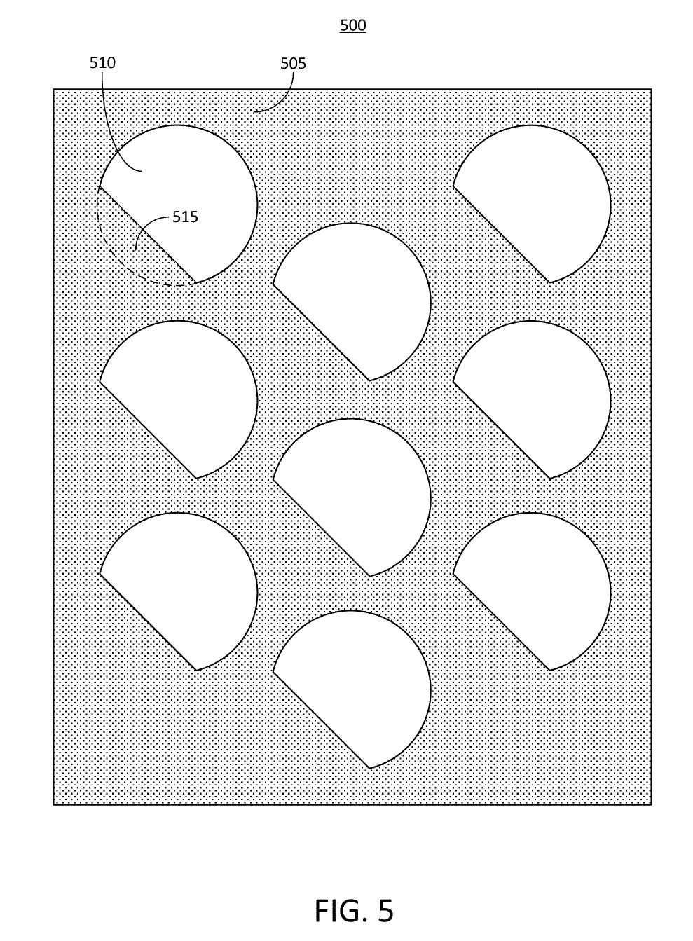

FIG. 5 depicts a top down view 500 of an example conductive layer 505 of a busbar. The conductive layer 505 can be a flat or planar component configured to provide a bonding surface to be electrically coupled with a plurality of battery cells, such as the battery cell battery cell 100. For example, by electrically coupling a first polarity terminal or a second polarity terminal of each of a plurality of battery cells 100 to the conductive layer 505, the conductive layer 505 can serve as a current collector for all of the battery cells 100. Thus, the battery cells 100 may be electrically connected in parallel through use of the conductive layer 505.

The conductive layer 505 can be used together with the conductive layer 405 of FIG. 4 to form at least a portion of a busbar. For example, the conductive layer 405 can serve as a current collector for the first polarity terminals of a plurality of batteries, and the conductive layer 505 can serve as a current collector for the second polarity terminals of the plurality of batteries. To facilitate such use, the conductive layer 505 can include a plurality of openings 510 that can each correspond to a respective one of the openings 410 of the conductive layer 405. For example, a shape and arrangement of the openings 510 of the conductive layer 505 can be similar to that of the openings 410 of the conductive layer 405.

The conductive layer 505 can also include a bonding region 515 for each opening 510. The bonding region 515 can be a portion of the surface of the conductive layer 505 that extends into a respective opening 510. Thus, when the conductive layer 505 and the conductive layer 405 are arranged in a stacked configuration in which the openings 510 are aligned with the openings 410, the openings 515 can still be accessible as they can extend beyond the edges of the conductive layer 505 to protrude into the openings 510. In some examples, the bonding regions 515 can be formed integrally with the conductive layer 505 and may be not be formed as separate components. For example, the shape of the openings 510 can be altered relative to that of the openings 410 of the conductive layer 405 to provide the bonding regions 515. Thus, the bonding region 515 depicted in FIG. 5 is shown with broken lines to indicate that it can be an integral part of the conductive layer 505.

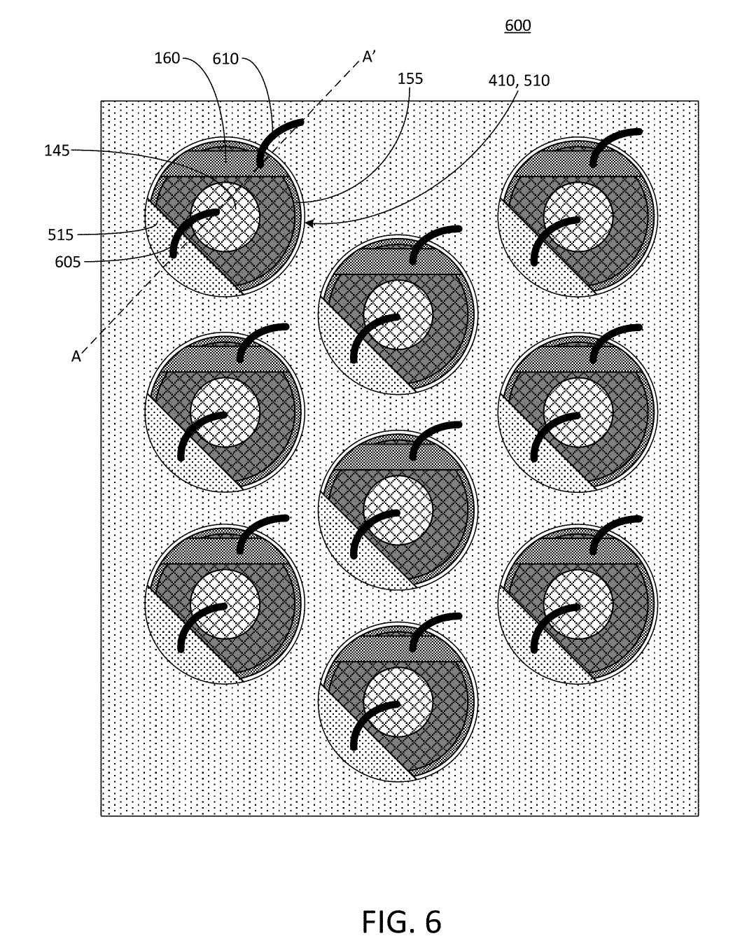

FIG. 6 depicts a top down view 600 of an example battery submodule including a plurality of batter cells 100. The submodule can also include the conductive layer 405 shown in FIG. 4 and the conductive layer 505 shown in FIG. 5. The conductive layer 405 and the conductive layer 505 can be arranged in a stacked configuration in which the openings 410 of the conductive layer 405 are aligned with the openings 510 of the conductive layer 505. As a result, the bonding regions 515 of the conductive layer 505 can extend beyond a footprint of the openings 410 of the conductive layer 405. Thus, the bonding regions 515 of the conductive layer 505 can be visible in the stacked configuration shown in FIG. 6, even though the conductive layer 505 is positioned beneath the conductive layer 405. The battery cells 100 can be oriented such that the bridges 160 do not overlap with the bonding regions 515 in the top down view 600. For example, the bonding region 515 may not extend over the bridge 160 in order to avoid interfering with electrical connections formed on the bridge 160. In other examples, the bonding region 515 may extend at least partially over the bridge 160.

The battery cells 100 are arranged in a manner that matches the arrangement of the openings 410 of the conductive layer 405 and the openings 510 of the conductive layer 505. For example, each pair of openings 410 and openings 510 can be positioned above a respective one of the battery cells 100. The battery cells 100 can also be electrically coupled to each of the conductive layer 405 and the conductive layer 505. For example, a first wire 605 can couple the first polarity terminal 140 of each battery cell 100 to the conductive layer 505. In particular, each first wire 605 can be bonded at one end to the upper portion 145 of each first polarity terminal 140 and can be bonded at an opposite end to a bonding region 515 of the conductive layer 505. Thus, all of the battery cells 100 can have their respective first polarity terminals 140 electrically coupled in parallel via the conductive layer 505.

A wire 610 can couple the bridge 160 of each battery cell 100 to the conductive layer 405. In particular, each wire 610 can be bonded at one end to the bridge 160 of each battery cell 100, and can be bonded at an opposite end to the surface of the conductive layer 405. The bridges 160 can be electrically coupled with the housings 105 of their respective battery cells 100, thereby enabling the bridges 160 to serve as second polarity terminals of the battery cells 100. Thus, all of the battery cells 100 can have their respective second polarity terminals electrically coupled in parallel via the conductive layer 405.

As can be seen in the top-down view 600 of FIG. 6, it may be difficult to bond the wire 610 to a lip 155 of a battery cell 100, due to the relatively small size of the lip 155 its proximity to the edges of the openings 410 and openings 510 of the conductive layer 405 and the conductive layer 505, respectively. However, by incorporating the bridges 160, which can be electrically coupled with the lips 155 of the battery cells 100, the available surface area for bonding the wires 610 to each battery cell 100 can be made significantly larger. As a result, more reliable bonding of the wires 610 can be accomplished.

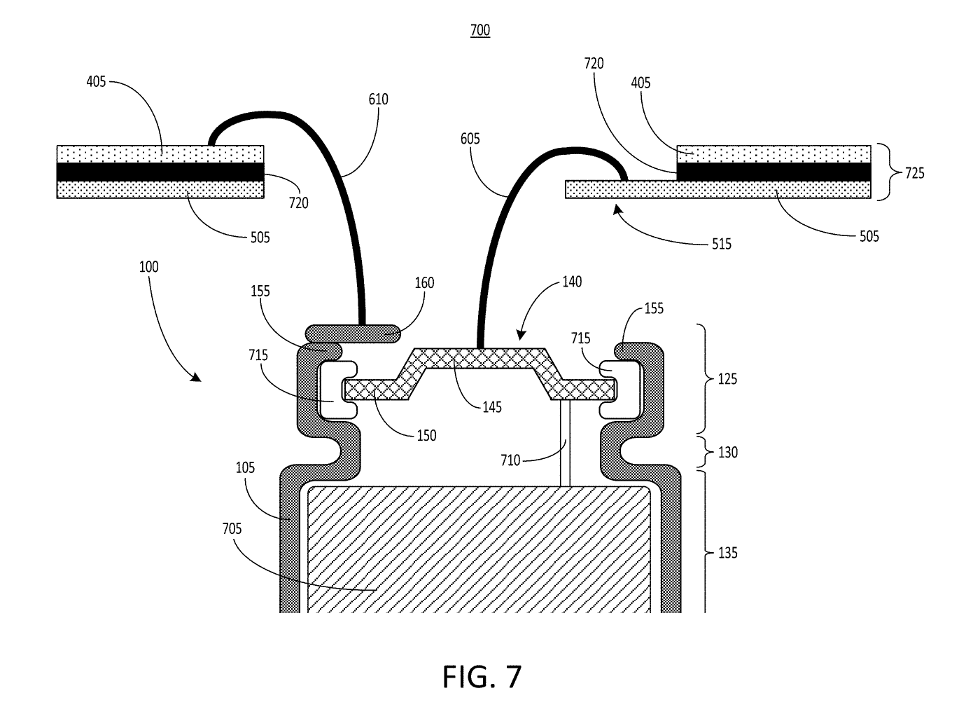

FIG. 7 depicts a cross-sectional view 700 of a portion of an example battery submodule and a busbar. The cross-sectional view of FIG. 7 is taken along the line A-A′ shown in FIG. 6. The body region 135 of the housing 105 can house a electrolyte material 705 or “jelly roll” 705. A connecting element 710 can electrically couple at least a portion of the electrolyte material 705 with the first polarity terminal 140. The first polarity terminal 140 can be supported within the head region 125 of the housing 105 by the neck region 130. The first polarity terminal 140 can be surrounded by a gasket 715. The gasket 715 can electrically insulate the first polarity terminal 140 from the housing 105, thereby allowing the housing 105 to serve as a second polarity terminal. The gasket 715 can also form a seal between the housing 105 and the first polarity terminal 140 to ensure that the electrolyte material 705 remains contained within the housing 105 and sealed from the external environment.

The conductive layer 405 and the conductive layer 505 can be electrically isolated from one another by an insulating layer 720. Together, the conductive layer 405, the conductive layer 505, and the insulating layer 720 can form a busbar 725. The insulating layer 720 can be arranged in a stacked configuration along with the conductive layer 405 and the conductive layer 505. For example, the insulating layer 720 can be a flat or planar component that can include openings having a similar size, shape, and arrangement as the openings 410 of the conductive layer 405. The insulating layer 720 can be formed, for example, from a non-conductive material, such as an electrically insulating plastic, rubber, or glass material.

The upper portion 145 of the first polarity terminal 140 can be positioned at a lower height than the bridge 160. For example, the upper portion 145 can be positioned between one millimeter and six millimeters below a height of the bridge 160. This lowering of the height of the upper portion 145 of the first polarity terminal 140 relative to the height of the bridge 160 that can function as the second polarity terminal terminal can provide a gap distance between the bridge 160 and the first polarity terminal 140. Such an arrangement can reduce or prevent cases of accidental shorting as well, because the bridge 160 can physically block conductive materials that could otherwise accidentally create a short circuit falling onto the battery cell 100. Further, this configuration can allow for battery cell designers and module/pack designers to work together to make wire bonding easier when scaling up battery packs, for example by increasing the wire bond success rate, e.g., above 60%. In some examples, the upper portion 145 of the first polarity terminal 140 can also be positioned above a height of the bridge 160.

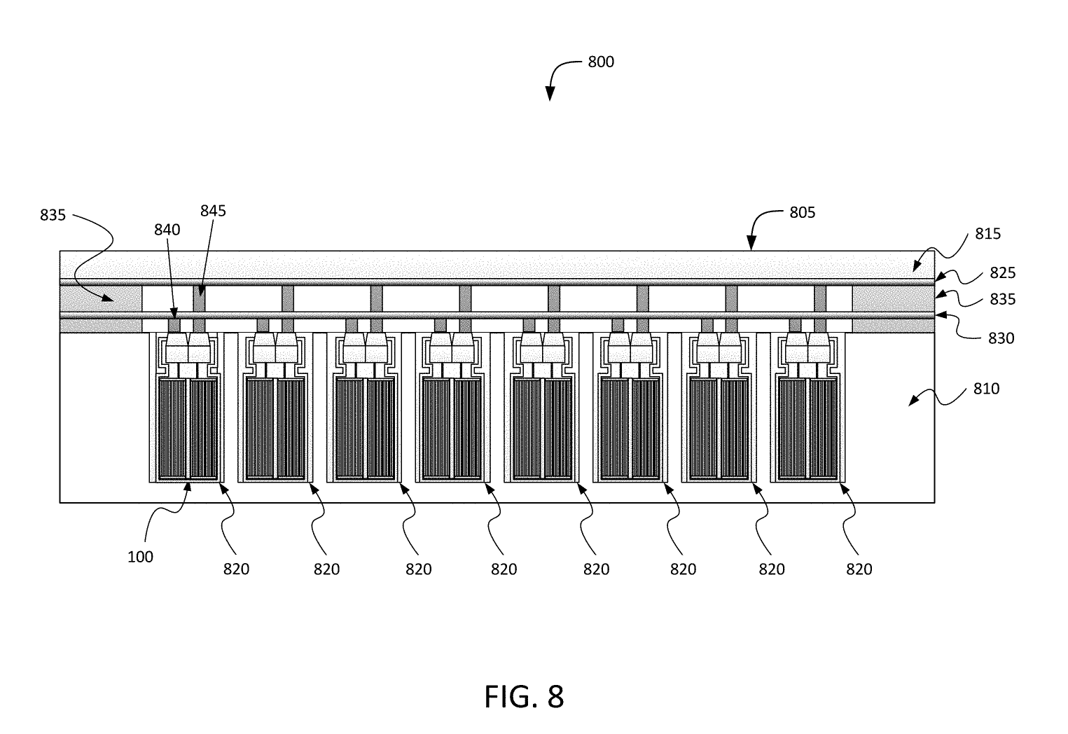

FIG. 8 depicts a cross-section view 800 of a battery pack 805 to hold a plurality of battery cells 100 in an electric vehicle. The battery pack 805 can include a battery module case 810 and a capping element 815. The battery module case 810 can be separated from the capping element 815. The battery module case 810 can include or define a plurality of holders 820. Each holder 820 can include a hollowing or a hollow portion defined by the battery module case 810. Each holder 820 can house, contain, store, or hold a battery cell 100. The battery module case 810 can include at least one electrically or thermally conductive material, or combinations thereof. The battery module case 810 can include one or more thermoelectric heat pumps. Each thermoelectric heat pump can be thermally coupled directly or indirectly to a battery cell 100 housed in the holder 820. Each thermoelectric heat pump can regulate temperature or heat radiating from the battery cell 100 housed in the holder 820. Bonding elements 850 and 855, which can each be electrically coupled with a respective one of the first polarity terminal 140 or the second polarity terminal (e.g., the bridge 160) of the battery cell 100, can extend from the battery cell 100 through the respective holder 820 of the battery module case 810.

Between the battery module case 810 and the capping element 815, the battery pack 805 can include a first busbar 825, a second busbar 830, and an electrically insulating layer 835. The first busbar 825 and the second busbar 830 can each include an electrically conductive material to provide electrical power to other electrical components in the electric vehicle. The first busbar 825 (sometimes referred to as a first current collector) can be connected or otherwise electrically coupled with the first bonding element 850 extending from each battery cell 100 housed in the plurality of holders 820 via a bonding element 845. The bonding element 845 can be bonded, welded, connected, attached, or otherwise electrically coupled with the bonding element 850. For example, the bonding element 845 can be welded onto a top surface of the bonding element 850. The second busbar 830 (sometimes referred to as a second current collector) can be connected or otherwise electrically coupled with the second bonding element 855 extending from each battery cell 100 housed in the plurality of holders 820 via a bonding element 840. The bonding element 840 can be bonded, welded, connected, attached, or otherwise electrically coupled with the second bonding element 855. For example, the bonding element 840 can be welded onto a top surface of the second bonding element 855. The second busbar 830 can define the second polarity terminal for the battery pack 805.

The first busbar 825 and the second busbar 830 can be separated from each other by the electrically insulating layer 835. The electrically insulating layer 835 can include spacing to pass or fit the first bonding element 850 connected to the first busbar 825 and the second bonding element 855 connected to the second busbar 830. The electrically insulating layer 835 can partially or fully span the volume defined by the battery module case 810 and the capping element 815. A top plane of the electrically insulating layer 835 can be in contact or be flush with a bottom plane of the capping element 815. A bottom plane of the electrically insulating layer 835 can be in contact or be flush with a top plane of the battery module case 810. The electrically insulating layer 835 can include any electrically insulating material or dielectric material, such as air, nitrogen, sulfur hexafluoride (SF₆), porcelain, glass, and plastic (e.g., polysiloxane), among others to separate the first busbar 825 from the second busbar 830. The busbars 825 and 830 can be similar to the first conductive layer 405 and the second conductive layer 505 of the busbar 725.

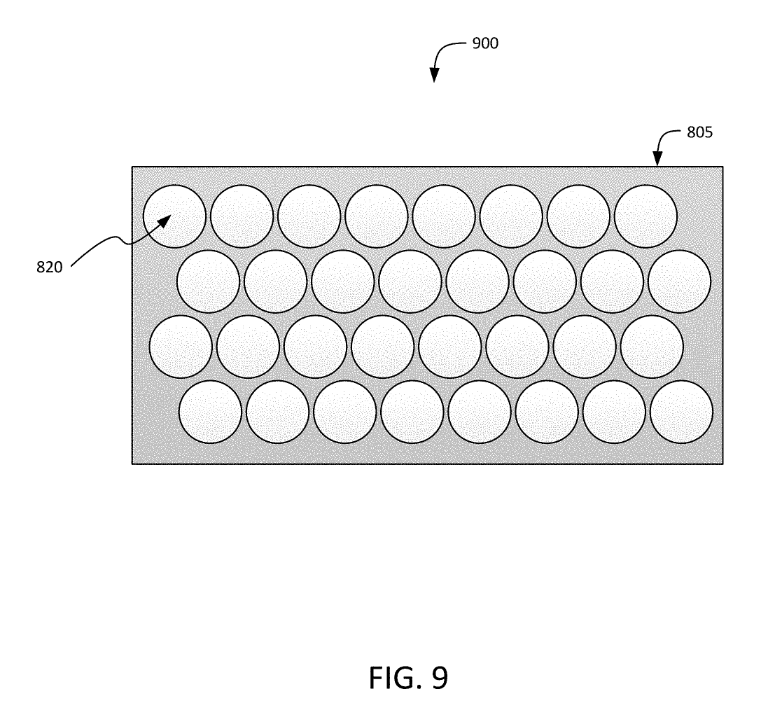

FIG. 9 depicts a top-down view 900 of a battery pack 805 to hold a plurality of battery cells 100 in an electric vehicle. The battery pack 805 can define or include a plurality of holders 820. The shape of each holder 820 can be triangular, rectangular, pentagonal, elliptical, and circular, among others. The shapes of each holder 820 can vary or can be uniform throughout the battery pack 805. For example, some holders 820 can be hexagonal in shape, whereas other holders can be circular in shape. The shape of the holder 820 can match the shape of a housing of each battery cell 100 contained therein. The dimensions of each holder 820 can be larger than the dimensions of the battery cell 100 housed therein.

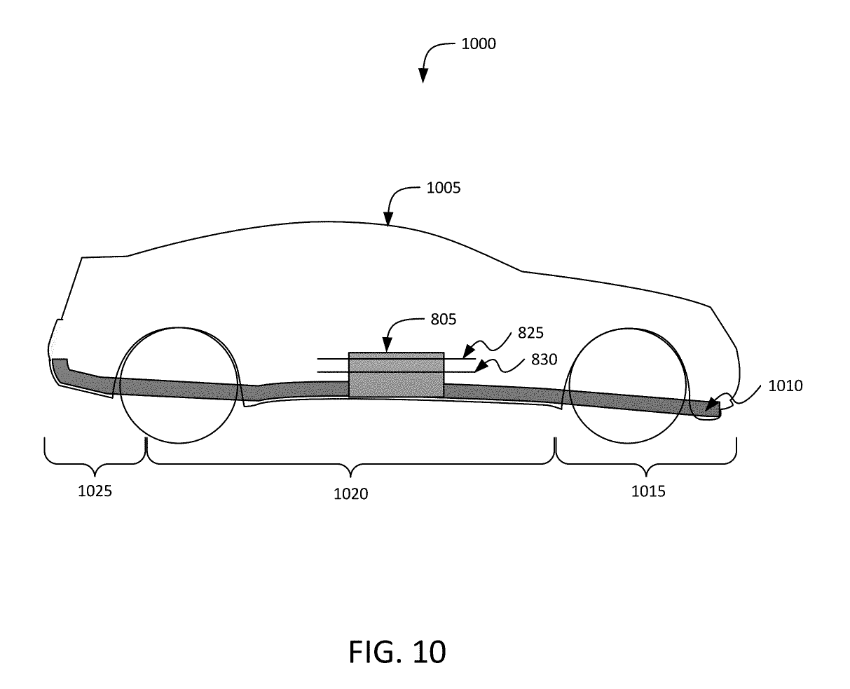

FIG. 10 depicts a cross-section view 1000 of an electric vehicle 1005 installed with a battery pack 805. The electric vehicle 1005 can include a chassis 1010 (e.g., a frame, internal frame, or support structure). The chassis 1010 can support various components of the electric vehicle 1005. The chassis 1010 can span a front portion 1015 (e.g., a hood or bonnet portion), a body portion 1020, and a rear portion 1025 (e.g., a trunk portion) of the electric vehicle 1005. The battery pack 805 can be installed or placed within the electric vehicle 1005. The battery pack 805 can be installed on the chassis 1010 of the electric vehicle 1005 within the front portion 1015, the body portion 1020 (as depicted in FIG. 10), or the rear portion 1025. The first busbar 825 and the second busbar 830 can be connected or otherwise be electrically coupled with other electrical components of the electric vehicle 1005 to provide electrical power. The battery cells 100 of FIGS. 8-10 also can each include a bridge 160 coupled to a lip 155 of a housing 105, in order to facilitate bonding of a wire that is electrically coupled to the housing 105.

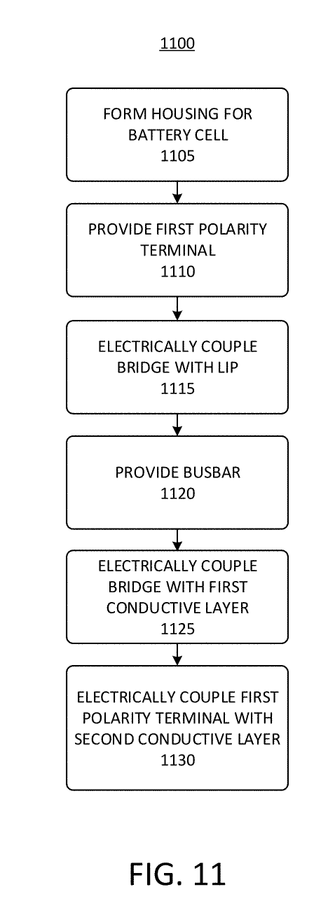

FIG. 11 depicts a flow chart of an example process 1100 of providing or manufacturing a battery pack. The process 1100 can include forming a housing 105 for a battery cell 100 (ACT 1105). The housing 105 can include an electrically conductive material, such as steel, nickel, nickel plated steel, aluminum, or copper. The housing 105 can be formed into a substantially cylindrical shape. In some examples, forming the housing 105 (ACT 1105) can also include subjecting the housing 105 to one or more crimping operations. For example, such a crimping operation can define a groove 115 to form a head region 125, a neck region 130, and a body region 135 of the housing 105. The process 1100 can also include providing a electrolyte material 705 within the housing 105, for example in the body region 135. The housing 105 can have a closed end 110 and an open end 120. The open end 120 of the housing 105 can define a lip 155.

The process 1100 can include providing a first polarity terminal 140 at a lateral end of the housing 105 (ACT 1110). The first polarity terminal 140 can be an electrically conductive component, such as a metal plate, positioned at the end of the housing 105. For example, the first polarity terminal 140 can include a lower portion 150 as well as an upper portion 145, also referred to herein as a “table top,” that is coupled to the lower portion 150 and rises to a height above the height of the lower portion 150. The first polarity terminal 140 can be positioned at the open end 120 of the housing 105. The lip 155 of the housing 105 can surround the first polarity terminal 140. The first polarity terminal 140 can be supported within the head region 125 of the housing 105, for example, by the neck region 130 of the housing 105. The first polarity terminal 140 can be electrically coupled with at least a portion of the electrolyte material 705 contained within the housing 105. The process 1100 can also include providing a gasket 715 to electrically insulate the first polarity terminal 140 from the housing 105 and to form a seal between the first polarity terminal 140 and the housing 105.

The process 1100 can include electrically coupling a bridge 160 with the lip 155 of the housing 105 to form a second polarity terminal (ACT 1115). For example, the bridge 160 can be a conductive element, such as a plate formed from a conductive material. The bridge 160 can be formed from steel, nickel, nickel plated steel, copper, or aluminum, for example. The bridge 160 can be secured to the lip 155 of the housing 105 using any type of bonding process that results in an electrical connection formed between the bridge 160 and the lip 155. For example, the bridge 160 can be welded to the lip 155 by ultrasonic welding, resistive spot welding, or laser welding. The bridge 160 may have a shape that conforms to at least a portion of the shape of the lip 155. The bridge 160 can have at least one edge that is curved to match a curvature of the lip 155, and that edge can be bonded to the lip 155 in a manner that does not increase or alter a footprint of the battery cell 100. The bridge 160 can extend over a portion of the first polarity terminal 140. For example, the bridge 160 can extend over the lower portion 150 of the first polarity terminal 140. The bridge 160 may also extend over the upper portion 145 of the first polarity terminal 140. For example, the first polarity terminal 140 can be shaped such that the upper portion 145 is positioned at a lower height than the bridge 160, allowing the bridge 160 to extend over at least a portion of the upper portion 145 of the first polarity terminal 140.

The process 1100 can include providing a busbar including a first conductive layer 405 having a first opening 410 aligned with the lip 155 and a second conductive layer 505 having a second opening 510 (ACT 1120). The conductive layer 505 can be electrically isolated from the conductive layer 405 by an insulating layer 720. The opening 410 of the conductive layer 405 can be shaped to match a cross-sectional shape of the battery cell 100. For example, in the battery cell 100 is generally cylindrical, the opening 410 of the conductive layer 405 can be circular and can have dimensions that match the cross-sectional dimensions of the battery cell 100. The opening 510 of the conductive layer 505 can be similar in shape to the opening 410 of the conductive layer 405, and can be arranged in alignment with the opening 410 of the conductive layer 405. For example, the conductive layer 505 and the conductive layer 405 can be arranged in a stacked configuration such that at least a portion of an edge of the opening 510 is aligned with a portion of the edge of the opening 410. In some examples, the conductive layer 505 can also include a bonding region 515 that may protrude into a footprint of the opening 410 of the conductive layer 405. For example, the bonding region 515 can have a size and shape that are the same as, or similar to, a size and shape of the bridge 160 that is bonded to the lip 155.

The process 1100 can include electrically coupling the bridge 160 with the first conductive layer 405 of the busbar 725 via a first wire 610 (ACT 1125). The bridge 160 can provide a surface area larger than that of the lip 155 in order to facilitate bonding of the wire 610 with the bridge 160. For example, the wire 610 can be bonded with the bridge 160 via a welding technique, such as ultrasonic welding, resistive spot welding, or laser welding. Similarly, the wire 610 can be bonded with the conductive layer 405 via any suitable form of welding technique.

The process 1100 can include electrically coupling the first polarity terminal 140 with the second conductive layer of the busbar 725 via a second wire 605 (ACT 1130). The wire 605 can be bonded with the upper portion 145 of the first polarity terminal 140, for example via a welding technique such as ultrasonic welding, resistive spot welding, or laser welding. Similarly, the wire 605 can be bonded with the conductive layer 505 via any suitable form of welding technique. In some examples, the wire 605 can be bonded to the bonding region 515 of the conductive layer 505, which may protrude into a footprint of the opening 410 of the conductive layer 405 in order to facilitate access of the conductive layer 505 for bonding of the wire 605.

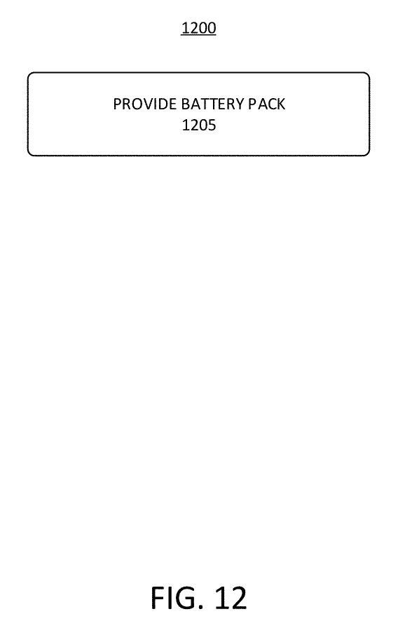

FIG. 12 depicts a flow chart of an example process 1200. The process 1200 can include providing a battery pack to power an electric vehicle (ACT 1205). The battery pack can include a battery cell 100. The battery cell 100 can include a first polarity terminal 140 disposed at a lateral end of the battery cell. The battery cell 100 can include a housing 105 having a closed end 110 and an open end 120. The open end 120 can define a lip 155 that surrounds the first polarity terminal 140. The battery cell 100 can include a second polarity terminal that includes the lip 155. The battery cell 100 can include a bridge 160 electrically coupled with the lip 155 and extending over a portion of the first polarity terminal 140. The battery pack can include a busbar 725. The busbar 725 can include a first conductive layer 405 having a first opening 410 aligned with the lip 155. The busbar 725 can include a second conductive layer 505 having a second opening 510. The battery pack can include a first wire 610 having a first end and a second end. The first end of the first wire 610 can be bonded with the bridge 160. The second end of the first wire 610 can be bonded with the first conductive layer 405 to electrically couple the second polarity terminal with the first conductive layer 405. The battery pack can include a second wire 605 having a first end and a second end. The first end of the second wire 605 can be bonded with the first polarity terminal. The second end of the second wire 605 can be bonded with the second conductive layer 505 to electrically couple the first polarity terminal with the second conductive layer 505.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, descriptions of positive and negative electrical characteristics may be reversed. For example, elements described as negative polarity elements can instead be configured as positive polarity elements and elements described as positive elements can instead by configured as negative elements. References to “first” polarity elements can include positive or negative polarity elements. References to “second” polarity elements can also include positive or negative polarity elements. For example, a first polarity terminal of the battery cell 100 can be a positive terminal and a second polarity terminal of the battery cell 100 can be a negative terminal, or vice-versa.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery pack to power an electric vehicle, comprising:
a battery cell comprising:
a first polarity terminal disposed at a lateral end of the battery cell;
a housing having a closed end and an open end, the open end defining a lip that surrounds the first polarity terminal;
a second polarity terminal comprising the lip;
a bridge electrically coupled with the lip and extending over a portion of the first polarity terminal;
a busbar comprising:
a first conductive layer having a first opening aligned with the lip;
a second conductive layer having a second opening;
a first wire having a first end and a second end, the first end of the first wire bonded with the bridge, the second end of the first wire bonded with the first conductive layer to electrically couple the second polarity terminal with the first conductive layer; and
a second wire having a first end and a second end, the first end of the second wire bonded with the first polarity terminal, the second end of the second wire bonded with the second conductive layer to electrically couple the first polarity terminal with the second conductive layer.

2. The battery pack of claim 1, comprising:
an insulating layer disposed between the first conductive layer and the second conductive layer.

3. The battery cell of claim 1, comprising:
a gasket to electrically insulate the first polarity terminal from the second polarity terminal.

4. The battery pack of claim 1, comprising:
the bridge including:
a first edge extending linearly over the first polarity terminal between a first point and a second point; and
a second edge having a curvature aligned with a portion of the lip between the first point and the second point.

5. The battery pack of claim 4, comprising:
the second edge of the bridge bonded with the lip.

6. The battery pack of claim 1, comprising:
the bridge including:
a first edge extending linearly over the first polarity terminal between a first point and a second point;
a second edge extending linearly in a direction parallel to the first edge between a third point and a fourth point;
a third edge having a curvature aligned with a first portion of the lip between the first point and the second point; and
a fourth edge having a curvature aligned with a second portion of the lip between the third point and the fourth point.

7. The battery pack of claim 6, comprising:
the third edge of the bridge bonded with the lip; and
the fourth end of the bridge bonded with the lip.

8. The battery pack of claim 1, comprising:
the second conductive layer of the busbar including a bonding region that extends over at least a portion of the battery cell.

9. The battery pack of claim 8, wherein:
a surface area of the bonding region of the second conductive layer is equal to a surface area of the bridge.

10. The battery pack of claim 8, wherein:
the bonding region of the second conductive layer does not extend over the bridge.

11. The battery pack of claim 1, wherein:
the bridge is disposed at a height below a peak height of the first polarity terminal.

12. The battery pack of claim 1, wherein:
the bridge is disposed at a height above a peak height of the first polarity terminal.

13. The battery pack of claim 1, wherein:
at least a portion of the housing is cylindrical.

14. The battery pack of claim 1, comprising:
the bridge comprises at least one of stainless steel, nickel plated steel, or nickel.

15. The battery pack of claim 1, comprising:
the bridge having a semicircular shape.

16. The battery pack of claim 1, comprising:
a plurality of additional battery cells.

17. The battery pack of claim 1, comprising:
The battery pack disposed in an electric vehicle to power electric vehicle.

18. A method of providing battery packs, comprising:
forming a housing for a battery cell of a battery pack having a plurality of battery cells, the housing having a closed end and an open end, the open end defining a lip;
providing a first polarity terminal at a lateral end of the housing, the housing defining a lip that surrounds the first polarity terminal;
electrically coupling a bridge with the lip of the housing to form a second polarity terminal, the bridge extending over a portion of the first polarity terminal;
providing a busbar comprising a first conductive layer having a first opening aligned with the lip and a second conductive layer having a second opening;
electrically coupling the bridge with the first conductive layer of the busbar via a first wire; and
electrically coupling the first polarity terminal with the second conductive layer of the busbar via a second wire.

19. The method of claim 18, comprising:
disposing a gasket at the open end of the housing to electrically insulate the first polarity terminal from the housing.

20. An electric vehicle, comprising:
a battery pack installed in the electric vehicle to power the electric vehicle, the battery pack comprising:
a battery cell comprising:
a first polarity terminal disposed at a lateral end of the battery cell;
a housing having a closed end and an open end, the open end defining a lip that surrounds the first polarity terminal;
a second polarity terminal comprising the lip;
a bridge electrically coupled with the lip and extending over a portion of the first polarity terminal;
a busbar comprising:
a first conductive layer having a first opening aligned with the lip;
a second conductive layer having a second opening;
a first wire having a first end and a second end, the first end of the first wire bonded with the bridge, the second end of the first wire bonded with the first conductive layer to electrically couple the second polarity terminal with the first conductive layer; and
a second wire having a first end and a second end, the first end of the second wire bonded with the first polarity terminal, the second end of the second wire bonded with the second conductive layer to electrically couple the first polarity terminal with the second conductive layer.
